(19) United States
(12) Patent Application Publication
(10) Pub. No.: US 2002/0035686 A1
(43) Pub. Date: Mar. 21, 2002

(54) Systems and methods for secured electronic transactions

(76) Inventors: Neal Creighton, Alpharetta, GA (US); Christopher T. M. Bailey, Atlanta, GA (US); Daniel P. Corcoran, San Jose, CA (US); Kefeng Chen, Duluth, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/906,460

(22) Filed: Jul. 16, 2001

Related U.S. Application Data
(60) Provisional application No. 60/218,149, filed on Jul. 14, 2000.

(51) Int. Cl. H04L 9/00

(52) U.S. Cl. 713/156; 705/76

(57) ABSTRACT

The present invention relates generally to methods and systems that enable organizations to make secure a wide array of electronic transactions such as business-to-business transactions over corporate extranets. One aspect of the present invention allows companies to create an extranet with business partners that they know. The extranet host provides to a certification authority a shared secret and the names of the business partners that are authorized to access the corporate extranet. If the requestor's shared secret and name matches a digital certificate is automatically issued. The invention allows a business to issue secured socket layer (SSL), Object Signing, Client authorization and secure email certificates to internal employees as well as issuing client authentication certificates to business partners.

### CROSS-REFERENCE TO RELATED APPLICATION

The application claims priority to U.S. Provisional Application Serial No. 60/218,149, entitled “System and Method for Secure Electronic Transactions,” filed on Jul. 14, 2000.

### FIELD OF THE INVENTION

The present invention relates generally to methods and systems that enable organizations to make secure a wide array of electronic transactions such as business transactions or e-mail over electronic networks. More particularly, it relates to a method and system for issuing digital certificates as online credentials to business partners in an extranet.

### BACKGROUND OF THE INVENTION

A leading cause of consumer reluctance to use the Internet is privacy/security of personal information. Until this issue is widely and adequately addressed, continued growth of e-commerce will be inhibited. Furthermore, as this medium for information transfer matures, authentication of identity will evolve from a relatively rare feature to a prerequisite for communicating electronically. As a result, the market for authentication grows as fast or faster than the overall e-commerce sector.

Encryption of information is normally undertaken to ensure privacy, that is, so that no one other than the intended recipient can decipher the information. Encryption is also undertaken to ensure the authenticity of the information, that is, a message that purports to originate with a particular source actually did and has not been tampered with.

A widely used method for encrypting traffic on the Internet is the Secure Sockets Layer (SSL) created by Netscape Communications. SSL uses a type of encryption known as public key encryption system. In a public key encryption system, each network participant has two related keys: a public key which is publicly available and a related private key or secret key which is not. The public key is used to encrypt information and the private key is used to decrypt information. Simply speaking, the public and private keys are separate, but mathematically linked algorithms for encrypting and decrypting. The public and private keys are duals of each other in the sense that material encrypted with the public key can only be decrypted using the private key. The keys utilized in public key encryption systems are such that information about the public key does not help to deduce the corresponding private key. The public key can be published and widely disseminated across a communications network, and material can be sent in privacy to a recipient by encrypting the material with recipient's public key. Only the recipient can decrypt material encrypted with the recipient's public key. Not even the originator who does the encryption using the recipient's public key is able to decrypt the encrypted material.

Message authentication can also be achieved utilizing encryption systems. In a public key encryption system, if the sender encrypts information using the sender's private key, all recipients will be able to decipher the information using the sender's public key, which is available to all. The recipients can be assured that the information originated with the sender, because the public key will only decrypt material encrypted with the sender's private key. Since presumably, only the sender has the private key, the sender cannot later disavow that he sent the information. However, no data security system is impenetrable. Public Key encryption systems are most vulnerable if the public keys are tampered with. Although encryption protects the confidentiality of a document, it does not verify that the person holding the key is the authorized key holder.

One way to prevent this from happening is through the use of digital certificates issued by a trusted third party. Digital certificates, that is, specially issued files containing identification and other information, provide a level of security and authentication that gives vendors, suppliers and others comfort as they increasingly commit to electronic commerce. Digital certificates provide electronic confirmation of the identity of a potential customer or other user seeking to access a server.

Currently, no technology provides a fully outsourced digital certificate solution for securing business-to-business (B2B) transactions in corporate extranets and other contexts. Existing public key infrastructure (PKI) offerings, such as those offered by Entrust, VeriSign, GTE and CyberTrust consist of a back-end hosting, but leave the registration and technical support functions to the customer. Moreover, existing PKI products require a business to perform its own native authentication and customer support. Other problems associated with existing PKI products are generally high cost and poor scalability. Thus, there is a need for a low-cost, scaleable, and completely outsourced method and system for providing secured electronic transactions in corporate extranets and other contexts.

### SUMMARY OF THE INVENTION

One aspect of the present invention relates to a method and system for securing electronic transactions between business partners in a limited access electronic network. The method comprises providing a limited access electronic network accessible only to authorized business partners who have obtained corporate digital certificates from at least one certification authority. The certification authority is accessible over a public network such as the Internet. The certification authority will first authenticate the identity of an authorized business partner and then issue to the partner a corporate digital certificate to be used as an online credential for accessing the limited access electronic network. Unlike existing methods and systems, the present invention system can be outsourced meaning, inter alia, that the certification authority performs the authentication of each business partner.

One illustrative embodiment of the present invention allows companies to create an extranet with business partners that they know. An extranet, as the term is used herein, is a limited access network created over the Internet to share information, applications, and services with designated customers, employees, business partners such as vendors, suppliers, contractors and others associated with an organization. The method includes an extranet host providing to this certification authority a shared secret (or public key) and the identity or name of each business partner authorized to access the extranet.

A business partner can access the certification authority system and request a digital certificate to be used as the online credential in its dealings with its business partners on the extranet. The certification authority will authenticate the identity of the business partner requesting the certificate, and then issue the digital certificate. Authentication may include the business partner entering a public key and a name, and if the public key and name entered by the business partner match those submitted to the certification authority by the extranet host a digital certificate is issued. The digital certificate identifies the business partner and may contain a public/private key set as well as a digital signature of the certification authority. This certificate is also referred to herein as a corporate certificate.

In another embodiment of the present invention, a certified business partner may designate at least one individual to be the primary point of contact between the certified partner and the certification authority. The certification authority authenticates the identity of this at least one individual and that individual is then known as the Registration Authority (RA) for the business-partner. Depending on the size and complexity of the organization, the RA may identify a number of employees to serve as Registration Individuals (RI). The RA may also have the authority to issue RI certificates to other business partners.

The RIs may be seen as sub-agents of RAs and are authorized to authenticate the identity of employees who require certificates for conducting business in the corporate extranet. The RIs may also be authorized to authenticate the identity of employees who require certificates for secure e-mail communications in the company's intranet. Typically, the RIs will authenticate the identity of employees who require these certificates and pre-register them with the certification authority. The individual employees will then be directed to access the certification authority to finalize their certificate registration. Thus, the present invention method obviates the need for the certification authority to authenticate every employee.

The systems and methods according to the present invention allow a certified business partner to issue secured socket layer (SSL), object signing, client authorization, and secure e-mail certificates to internal employees as well as issuing client authentication certificates to other business partners.

The systems and methods according to the present invention can be partially or fully outsourced, cost effective, easy to implement, fast to deploy, and highly scaleable. They are designed to serve companies that desire to outsource a web browser-based Internet security solution. The methods and systems of the present invention offer cost advantages over prior art products, because of their technical framework, as well as their implementation and distribution methodology. Cost and scaleability are main concerns of prior art products.

### BRIEF DESCRIPTION OF THE DRAWINGS

FIG. 1 is a simplified block diagram illustrating the various authentication authorities, according to one embodiment of the present invention.

FIG. 2 is a simplified block diagram of a certification authority system coupled to the Internet, according to an embodiment of the invention.

FIG. 3 is a block diagram of the present invention method for creating a limited access electronic network, according to one embodiment of the present invention.

FIGS. 4, 5, 6, and 8 are illustrative examples of web interfaces, according to one embodiment of the present invention.

FIG. 7 is an illustrative example of a registration form, according to one embodiment of the invention.

### DETAILED DESCRIPTION OF THE INVENTION

The present invention offers methods and systems for managing secured transactions in limited access computer networks such as corporate extranets. Moreover, it offers low initial setup cost, and it is readily scaleable. It allows organizations to extend the reach of their business applications to all of their constituents in a secure manner. The invention can be implemented with large, medium and small companies and institutions that desire an economical way to authenticate the identity of their business partners, and employees who can access the corporate extranet or other communications infrastructure.

The systems and methods according to the present invention allow business customers trading in a private inter company network (extranet) to manage the issuance, maintenance, and revocation of client certificates using a secured web site provided by a certification authority. In one embodiment, a customer who desires a digital certificate designates at least one individual to be the primary point of contact between the customer and the certification authority. The identity of this individual (or individuals) is authenticated by the certification authority and this person is then known as the registration authority (RA) for that client.

Depending on the size and complexity of the customer's organization, the RA may identify a number of registration individuals (RIs). The individuals designated as RIs are given the authority to authenticate the identity of employees who require certificates for the purpose of secure e-mail in the company's intranet or for conducting business with suppliers or customers in a corporate extranet. The methods and systems of the present invention further allow the RA of a certified business partner to authenticate other partners.

The RIs authenticate the identity of the employees who require the certificates and pre-register them with the certification authority. The individual employees will subsequently be directed by the RIs to access a secured web site provided by the certificate authority in order to finalize their certificate registration.

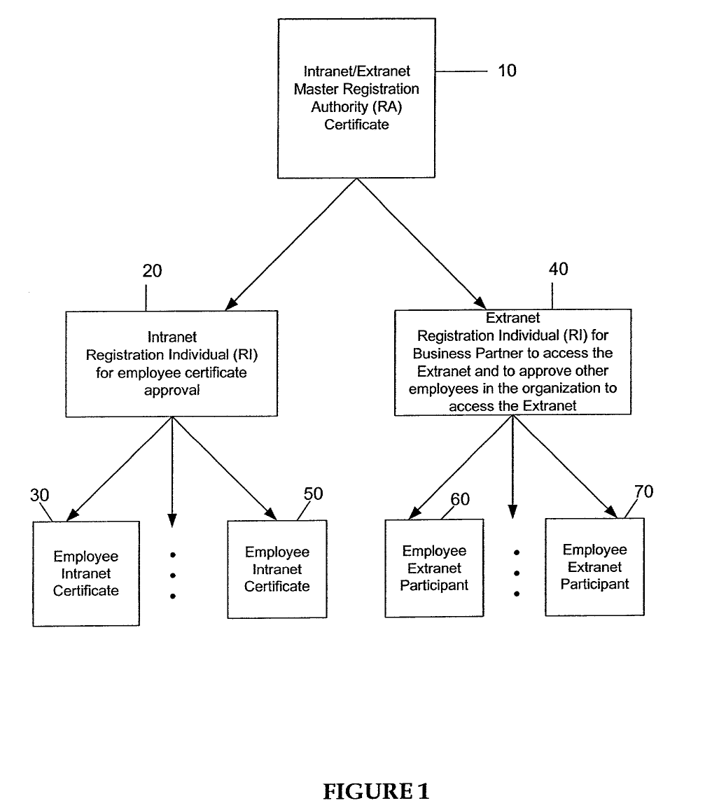

FIG. 1 shows the hierarchy of the various authentication authorities, according to an embodiment of the present invention method and system. Accordingly, the certification authority (CA) may issue a master registration authority (RA) certificate to at least one individual that will serve as the primary point of contact between the certification authoring and the business partner, according to block 10. The RA may then identify at least one intranet registration individual for employee certificate approval, according to block 20. The RA may also identify at least one extranet registration individual for the business partner who may access the extranet and may also approve other employees in the organization to access the extranet, according to block 40. The intranet registration individual is authorized to authenticate the identity of employees who will be issued certificates for the purpose of secure e-mail in the company's intranet, according to blocks 30-50. The extranet registration individual may authenticate the identity of employees who will be issued certificates for conducting business with business partners on the extranet, according to blocks 60-70.

The certification authority will typically charge a variable fee for issuing these certificates. The certificate authority will also typically provide technical support of all certificates issued, including, but not limited to storing, maintaining, and revoking of the digital certificates. The present invention offers low start-up cost, accelerated time-to-market, and reduced or no administration costs since the certification process is managed by the certification authority. Thus, the certification authority manages the processes and the technology associated with digital certificates in a manner that minimizes customer effort, but still allows customer control over the process. With the RA acting as the primary contact point, the present invention facilitates the initial certificate holder setup, certificate issuance and distribution, certificate renewal, certificate replacement, and certificate revocation.

The systems and methods according to the present invention may also provide customers with the ability to have their certificates stored in a database or storage device preferably located in the certification authority server. A customer may also receive copies of its certificate or certificates issued in order to create a local Permissions Management Infrastructure (PMI). The PMI will allow a customer to audit the certificates, and therefore the authority issued to its employees.

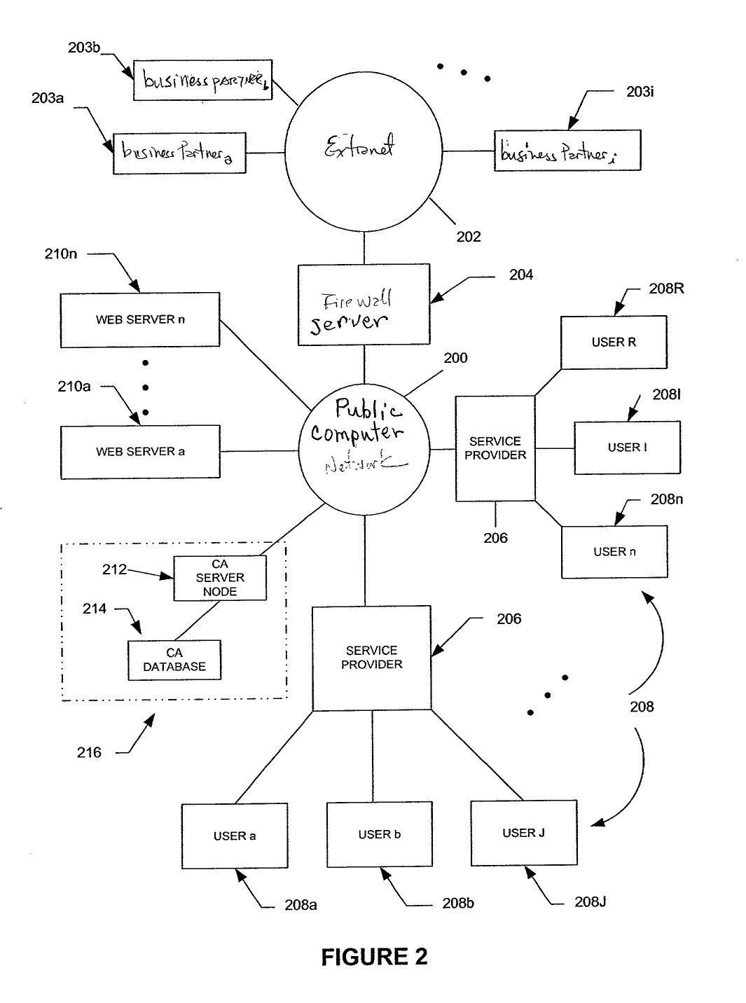

Referring now to FIG. 2, a certification authority (CA) system 216 is coupled to a public computer network or internet 200. As used herein, the term “internet” generally refers to any collection of distinct networks working together to appear as a single network to a user. The term “Internet” refers to the so-called worldwide “network of networks” that are connected to each other using the Internet protocol (IP) and other similar protocols. The Internet provides file transfer, remote login, electronic mail, news and other services.

As described herein, the exemplary public network of FIG. 2 is for descriptive purposes only. Although the description may refer to terms commonly used in describing particular public networks such as the Internet, the description and concepts equally apply to other public and private computer networks, including systems having architectures dissimilar to that shown in FIG. 2.

One of the unique aspects of the Internet system is that messages and data are transmitted through the use of data packets, “datagrams.” In a datagram-based network, messages are sent from a source to a destination in a similar manner to a government mail system. For example, a source computer may send a datagram packet to a destination computer regardless of whether or not the destination computer is currently online and coupled to the network. This Internet protocol (IP) is completely sessionless, such that IP datagram packets are not associated with one another.

A limited access intercompany network 202 (extranet 202) connecting business partners 203a-203i is also coupled to the public network 200 through the firewall server 204. Extranet 202 may be built in all sorts of ways using all kinds of methods. However, users must be authenticated according to the present invention method and system. The firewall server 204 is a computer that couples the computers of a private network, e.g., network 202 to the Internet 200 and may, thus, act as a gatekeeper for messages and datagrams going to and from the Internet 200. Internet or extranet service providers 206 are also coupled to the Internet 200. A service provider 206 is an organization that provides connections to a part of the Internet. An extranet service provider 206 provides the management and security infrastructure that allows for the creation of a secured extranet over the Internet. Service provider 206 is also a server that couples a plurality of users 208a-208n to the Internet in a plurality of web sites or nodes 210a-210n generally denoted 210. When a user wishes to conduct a transaction at one of the nodes 210, the user accesses the node 210 through the Internet 200.

Though represented singularly in FIG. 2, it is understood that there may be other firewall servers or similar functionality connected to the Internet 200 linking other private networks to the Internet 200. Each node in the firewall shown in FIG. 2 is configured to understand which firewall and node to send data-packets to a given designated IP address. This may be implemented by providing the firewalls and nodes with a map of all valid IP addresses disposed on its particular private network or another location on the Internet. The map may be in the form of a prefix matched-up to and including the full IP address.

The certification authority (CA) system 216 comprises a certification authority server 212 and a certification storage device or database 214. Customers can store, if they so choose, the digital certificates in the certificate database 214. The certificates can be stored, for example, as a record or as a file. Thus, the certificate authority system 216 includes a database of customer certificates for each of the customers who wish to utilize the certification authority as a depository for their certificates.

CA system 216 may be provided, for example, as an object-oriented database management system (DBMS), a relational database management system (e.g. DB2, SQL, etc.) or other conventional database packages that include a security/authentication function. Thus, the database can be implemented using object-oriented technology or via text files which utilize a security system.

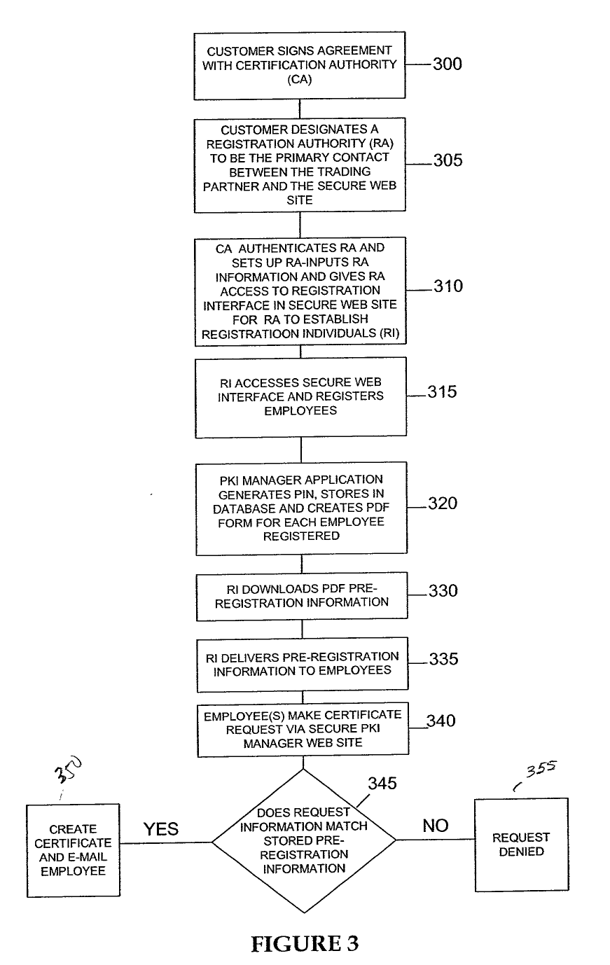

Referring now to FIG. 3, the certification authority system 216 operates in the following manner, according to a preferred embodiment of the present invention. A customer, such as a business partner in an extranet, who wishes to obtain digital certificates to use as online credentials signs an agreement with the provider of the certification authority system 216, according to step 300. Then each customer designates an individual known as the registration authority (RA) to be the primary contact between the customer and the certificate authority, according to step 305.

The certification authority authenticates the RA and sets up the RA in the certification authority system, according to step 310. The set-up includes entering RA information in the computer and giving access to the RA to a registration interface to establish registration individuals (RIs), according to step 310. The RIs can then securely access a registration graphical user interface (GUI) in a secured web site offered by the certification authority and register employees, for example, by uploading an excel spreadsheet or using an HTML form, according to step 315. The certification authority system generates a user identification code and a personal identity number (PIN), stores them in the database, and creates a PDF (portable document format) form for each registered employee, according to step 320. This is preferably done in real time. The RI's can download the PDF form with the pre-registration information, according to step 330, and securely deliver it, for example, in a sealed envelope to that employee, according to step 335. The delivery of the PDF form can also be done through other secure electronic transmissions. The employee can then make a certificate request via the secured web site provided by the certification authority, according to step 340. The employees are asked to enter their user identification code and PIN and also enter registration information, for example using an HTML form. As an additional authentication step a determination is then made whether the employee's pre-registration information stored in the certificate database matches the pre-registration information entered into the request, according to block 345. If it matches, then a digital certificate is created and e-mailed to the employee, according to block 350. If the information in the request does not match the stored pre-registration information, then the request is denied, according to block 355. Fulfillment of the whole process will typically take less than a few minutes to be completed, generally less than about three minutes.

A digital certificate issued to an authenticated employee may contain among other information the employee's identification information, the company's information, the level of authority, typically expressed in terms of dollar, granted by the company to this employee, etc. The company can determine what information to include in a digital certificate by providing this information to the certification authority while pre-registering the employee.

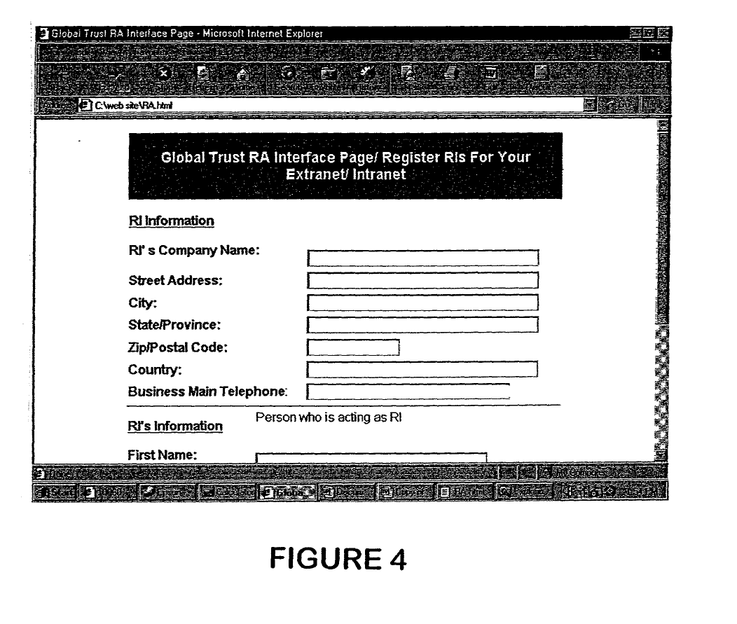

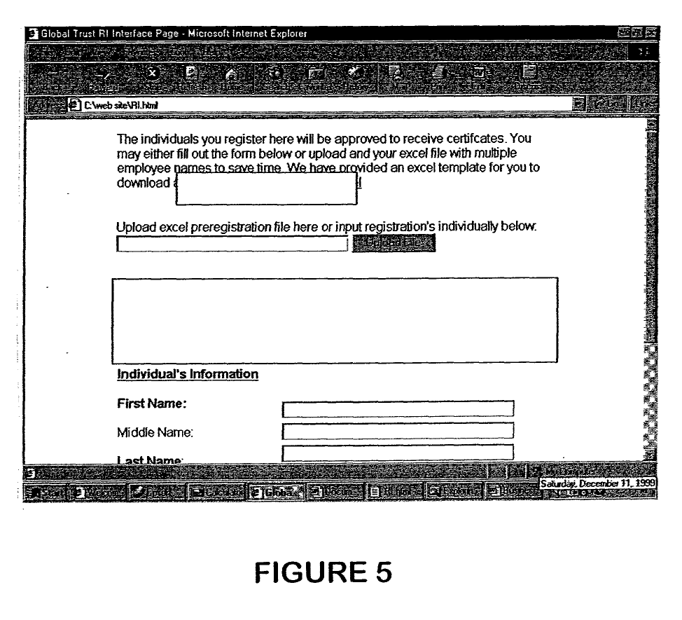

FIGS. 4 and 5 are illustrative examples of web interfaces for the certification authority system. Customers (RAs/RIs) use these interfaces to register individuals to receive and to request certificates. For example, as discussed above, a registration authority (RA) interfaces with the web site of the certification authority system to register responsible individuals (“RIs”) for secure extranet transactions and Intranet e-mail. The RIs use a different web interface shown in FIG. 5 to register individuals entitled to receive certificates within their companies/departments. The registration can be done by entering names of each individual one-by-one, or uploading a spreadsheet, such as an Excel spreadsheet, with a list of individuals.

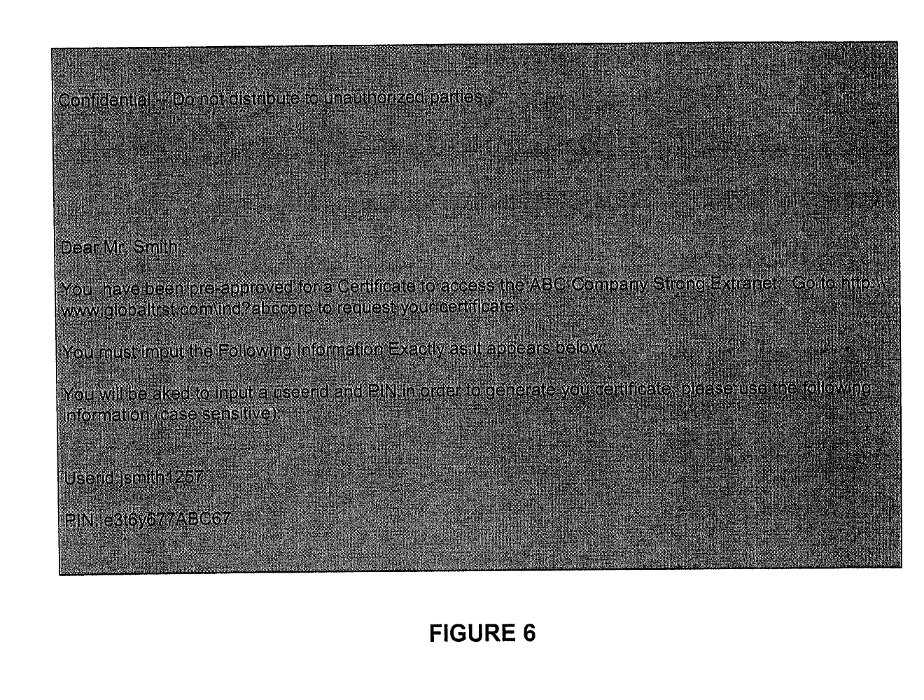

After an RI registers an individual, the certificate authority system will create (real-time) PDF registration forms that the RI can deliver via secure channel to individuals. An example form is shown in FIG. 6.

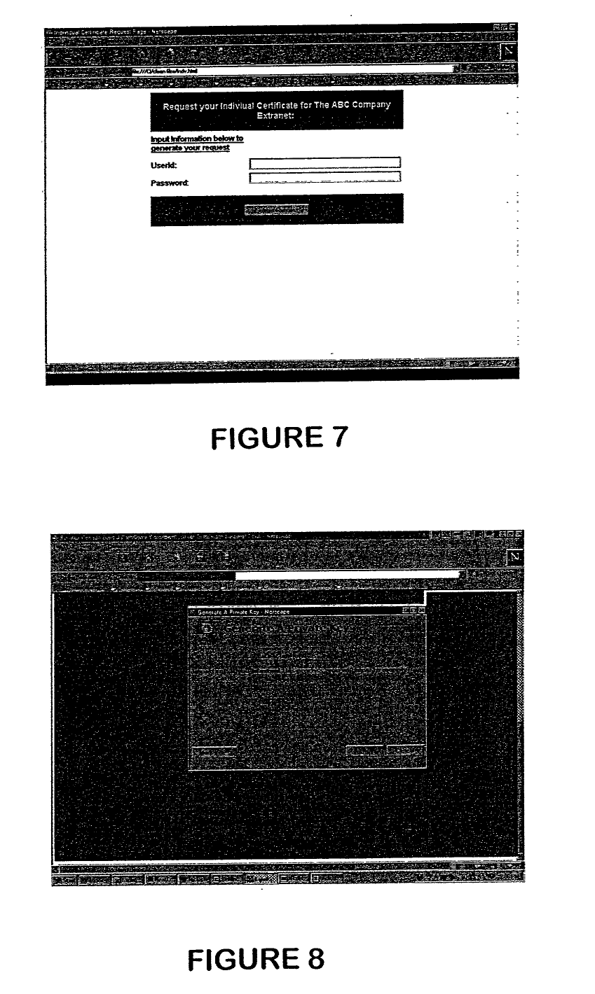

Once individuals receive their registration information, which includes a user identification code and a PIN, they may visit the secure web site of the security authority system and request their certificate. When the correct user identification code/PIN is received, and any other additional authentication steps are completed successfully, a certificate that comprises the employee's name, the certificate's validity period and function is generated. FIGS. 6 and 7 illustrate two screens used for an individual to request a digital certificate.

In an alternate embodiment, the RI can also revoke the authentication of an individual. The RI accesses CA's web site to remove individuals from the list of authenticated users, and then the CA will no longer issue a digital certificate to these individuals and invalidate the digital certificates already issued. The CA may also publish a list of invalid digital certificates and inform those limited access web sites about the invalid digital certificates. The limited access web sites are responsible for updating their database to deny access to those individuals who present invalid digital certificates.

The present invention's methods and systems are advantageous compared to existing methods and systems for a number of reasons. First, it is easier for customers to implement the certificate authority system of the present invention than existing products since it can be an outsourced offering that requires fewer customer resources. In addition, a present invention outsourced approach requires the customers to undertake significantly less up-front expense. The present invention's methods and systems are scalable and allow customers to purchase only as much product as they need. Furthermore, they offer increased security and access control for corporate extranets. Corporate extranet usage is expanding quickly, because companies can utilize the Internet and security measures to replace more expensive dedicated communication lines.

It is to be understood that the embodiments and variations shown and described herein are merely illustrative of the principles of this invention and that various modifications may be implemented by those skilled in the art without departing from the scope and spirit of the invention. In disclosing the invention in this document, terms such as “firewall,” “server,” “Internet,” “network,” “intranet,” “extranet,” “digital certificate,” “storage device,” and “database,” include such functionalities, plus any other functionalities, whether existing at the time of this document or in the future, which are not substantially different, or which function substantially the same way to achieve substantially the same result. Such functionalities can be implemented in one location or multiple; in hardware of software; actually or virtually, distributed or nondistributed, networked or non-networked, circuit switched or packet switched, electronically or nonelectronically, optically or nonoptically, biologically or nonbiologically.

We claim:

1. A method for securing electronic transactions between business partners in a limited access electronic network, wherein the limited access electronic network is accessible only to authorized business partners who have obtained digital certificates from a certification authority, the method comprising:
selecting a certification authority accessible over a public network;
designating at least one individual as a registration agent authorized to authenticate the identity of employees who require digital certificates for the purpose of secure e-mail intranet transactions or conducting electronic business transactions with said business partners in said limited access electronic network;
authenticating the registration agent;
pre-registering the employees with the certification authority, wherein the employees are authenticated by the registration agent;
authenticating the employees;
issuing a digital certificate to the at least one of the employees.

2. The method of claim 1, wherein said limited access electronic network employs public key infrastructure technology.

3. The method of claim 1, wherein said limited access electronic network comprises at least one server accessible only to said authenticated business partners who have obtained digital certificates through the Internet or a direct, dial-up connection, and wherein said server of said limited access network has no direct link to a host server that provides content to the server of said limited access network.

4. The method of claim 1, wherein said the step of authenticating the employees further comprises
providing to the certification authority a personal identification code and a PIN.

5. The method of claim 1, wherein the step of pre-registering the employees further comprises
providing the identity information of the employees to the certification

6. A method for issuing digital certificates as online credentials to business partners trading in an extranet, the method comprising:
providing a certification authority, wherein the certification authority is capable of issuing digital certificates;
identifying a registration agent, the registration agent having the authority to identify employees entitled to receive the digital certificates;
pre-registering the employees entitled to receive the digital certificates, the pre-registration being done by the registration agent;
requesting a pre-registered employee to enter pre-registration information; and
issuing a digital certificate to the pre-registered employee if the pre-registration information entered by the pre-registered employee matches the pre-registration information in the database for that employee.

7. The method of claim 6 further comprising:
generating a user identification code and a personal identification number (PIN) for the pre-registered employee; and
directing the pre-registered employee to obtain a digital certificate by using the secure web site.

8. The method of claim 6, wherein the registration agent identifies at the least one registration individual, said at the least one registration individual having the authority to identify employees entitled to receive digital certificates.

9. The method of claim 8, wherein the at least one registration individual is responsible for pre-registering employees entitled to receive digital certificates.

10. The method of claim 6, wherein the registration agent has the authority to revoke the digital certificate already issued to an employee, the revocation comprises
removing the employee from a list of authenticated users.

11. The method of claim 6, wherein the revocation further comprises invalidating the digital certificate already issued to the employee, and informing extranet host about the invalid digital certificate.

12 A system for securing electronic transaction between business partners in an extranet the system comprising:
a certification authority system coupled to the extranet, wherein the certification authority system comprises
a certification authority server, wherein the certification authority server has a user interface and is capable of generating digital certificates, and
a certification authority database, wherein the certification authority database tracks individuals entitled to receive a digital certificate; and
a firewall server connecting the extranet to the Internet,
wherein a registration agent can pre-register with the certification authority individuals entitled to receive digital certificates and to transact with other business partner, the pre-registered individuals are listed in the certification authority database,
the certification authority is responsible for authenticating the identity of a business partner requesting a digital certificate, and
the certification authority is capable of issuing a digital certificate that can be used as an online credential to access the extranet to the business partner.
